(19) United States
(12) Patent Application Publication
(10) Pub. No.: US 2023/0319780 A1
(43) Pub. Date: Oct. 5, 2023

(54) RECEIVING COLLECTED DATA FROM A GROUP OF DEVICES

(71) Applicant: Lenovo (Singapore) Pte. Ltd., New Tech Park (SG)

(72) Inventors: Hyung-Nam Choi, Ottobrunn (DE); Hyejung Jung, Northbrook, IL (US); Joachim Loehr, Wiesbaden (DE); Ravi Kuchibhotla, Chicago, IL (US); Prateek Basu Mallick, Dreieich (DE); Vijay Nangia, Woodridge, IL (US)

(21) Appl. No.: 18/024,931

(22) PCT Filed: Sep. 6, 2021
(86) PCT No.: PCT/IB2021/058109

§ 371 Date: Mar. 6, 2023

Related U.S. Application Data
(60) Provisional application No. 63/075,052, filed on Sep. 4, 2020.

(51) Int. Cl. H04W 68/02; H04W 76/10

(52) U.S. Cl. CPC H04W 68/02; H04W 76/10

(57) ABSTRACT

Apparatuses, methods, and systems are disclosed for retrieving collected data from a group of devices. One apparatus includes a processor and a transceiver that receives a first request message indicating a group communication mode of a first UE. The processor identifies a group of second UEs associated with the first request message and the transceiver sends a paging message to the identified group to transfer collected data. The transceiver further receives at least one second request message from at least one second UE of the identified group and the processor establishes a data connection with each of the at least one second UE to receive the collected data.

### CROSS-REFERENCE TO RELATED APPLICATIONS

This application claims priority to U.S. Provisional Patent Application No. 63/075,052 entitled “RETRIEVING DATA FROM A GROUP OF DEVICES” and filed on Sep. 4, 2020 for Hyung-Nam Choi, Joachim Loehr, Hyejung Jung, Ravi Kuchibhotla, Prateek Basu Mallick, and Vijay Nangia, which application is incorporated herein by reference.

### FIELD

The subject matter disclosed herein relates generally to wireless communications and more particularly relates to retrieving data from a group of devices.

### BACKGROUND

In various embodiments, a wireless communication supports two types of paging on the radio interface. CN-initiated paging may be used to reach a UE in a non-connected state, such as RRC_IDLE state or RRC_INACTIVE state. RAN-initiated paging may be used to reach a UE in RRC_INACTIVE state.

### BRIEF SUMMARY

Disclosed are procedures for retrieving data from a group of devices. Said procedures may be implemented by apparatus, systems, methods, or computer program products.

One method of an Access and Mobility Management Function (“AMF”) for retrieving collected data from a group of devices includes receiving a first request message that indicates a group communication mode of a first User Equipment (“UE”) device. The method includes identifying a group of second UE devices associated with the first request message and sending a paging message to the identified group to transfer collected data. The method includes receiving at least one second request message from at least one second UE device of the identified group and establishing a data connection with each of the at least one second UE device to receive the collected data.

One method of a Radio Access Network (“RAN”) for retrieving collected data from a group of devices includes receiving a first request message from a first UE device requesting the establishment of resources to send collected data. The method includes determining a group communication mode from the first request message and transmitting a message to a core network entity requesting to page a group of UE devices. The method includes receiving a paging message from the core network entity with information for paging the group of UE devices to transfer collected data and transmitting a Radio Resource Control (“RRC”) paging message to the group of UE devices requesting the establishment of resources to send the collected data.

One method of a UE device for retrieving collected data from a group of devices includes collecting data according to a configuration received from an application function. The method includes determining that a condition for event-triggered data retrieval is met and transmitting a first request message to establish resources to send the collected data. The method includes receiving a RRC paging message with information requesting the establishment of connection to send collected data and determining whether to establish a connection to send collected data in response to receiving the RRC paging message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for retrieving data from a group of devices;

FIG. 2 is a diagram illustrating one embodiment of retrieving data from a group of devices;

FIG. 3A is a call-flow diagram illustrating another embodiment of retrieving data from a group of devices;

FIG. 3B is a continuation of the call-flow diagram in FIG. 3B;

FIG. 4 is a call-flow diagram illustrating a further embodiment of retrieving data from a group of devices;

FIG. 5 is a diagram illustrating one embodiment of a RRCSetupRequest message;

FIG. 6 is a call-flow diagram illustrating an additional embodiment of retrieving data from a group of devices;

FIG. 7 is a block diagram illustrating one embodiment of a Fifth-Generation (“5G”) New Radio (“NR”) protocol stack;

FIG. 8 is a block diagram illustrating one embodiment of a user equipment apparatus that may be used for retrieving data from a group of devices;

FIG. 9 is a block diagram illustrating one embodiment of a network apparatus that may be used for retrieving data from a group of devices;

FIG. 10 is a flowchart diagram illustrating one embodiment of a first method for retrieving data from a group of devices;

FIG. 11 is a flowchart diagram illustrating one embodiment of a second method for retrieving data from a group of devices; and

FIG. 12 is a flowchart diagram illustrating one embodiment of a third method for retrieving data from a group of devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“AA/LAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for retrieving data from a group of devices. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

On radio interface, two types of paging are defined:
CN-initiated paging to reach a UE in RRC_IDLE and RRC_INACTIVE
RAN-initiated paging to reach a UE in RRC_INACTIVE

The Paging Occasions (“POs”) of a UE for CN-initiated and RAN-initiated paging are based on the same UE identity, resulting in overlapping POs for both. The number of different POs in a Discontinuous Reception (“DRX”) cycle is configurable via system information and a network may distribute UEs to those POs based on their identities. The RAN node uses the Paging message to transmit paging information to a UE in RRC_IDLE or RRC_INACTIVE. An RRC Paging message may contain up to 32 paging records and each paging record may contain as paging UE identity either NG-5G-S-TMSI (in case of Core Network (“CN”)-initiated paging) or I-RNTI-Value (in case of RAN-initiated paging). The AccessType indicates whether the Paging message is originated due to the PDU sessions from the non-3GPP access.

In case of CN-initiated paging for a UE the AMF sends the NG Paging message to the RAN node. At the reception of the Paging message, the RAN node performs paging of the UE in cells which belong to tracking areas as indicated in the TAI List for Paging IE. For each cell that belongs to any of the tracking areas indicated in the TAI List for Paging IE, the RAN node generates one page on the radio interface.

In case of RAN-initiated paging the old serving RAN node may send a Xn RAN paging message to other RAN nodes of the RAN notification area to request paging of a UE by the other RAN nodes. The Xn RAN Paging message provides the UE RAN Paging Identity.

Disclosed are procedures for retrieving data collected from a group of devices. In order to efficiently support the concept of retrieval of data collected from a group of devices further modifications/enhancements to existing messages and procedures in 3GPP are proposed:
1) The existing RRC Paging message, NG Paging message, Xn RAN Paging message are extended by following new parameters: a) Paging cause that may be set to following value: {MO data retrieval}; b) Traffic type that may be set to following values: {temperature, pressure, humidity, motion, location, orientation, audio, video}.
2) The existing NAS Service request message and PDU session establishment request messages, and the new NG Paging request message contain the following new parameters: a) Group communication mode identity; b) Traffic type that may be set to following values: {temperature, pressure, humidity, motion, location, orientation, audio, video}.
3) Transmission of new information on RRC indicating the type of data: a) Sent by network to UE in a new MAC control element which is multiplexed either in the random access response (RAR) message (i.e., step 2 in 4-step Random-Access procedure) or contention resolution message (i.e., step 4 in 4-step Random-Access procedure or MsgB in 2-step Random-Access procedure) during random access procedure or the new information indicating the data type is included in the UL grant in the RAR message; b) Sent by UE to network as new cause value in UL RRC messages (e.g., RRCSetupRequest or RRCResumeRequest messages) or in a new MAC control element which is multiplexed either in the MsgA (in 2-step Random-Access procedure) or in Msg3 (in 4-step Random-Access procedure) during random access procedure.

Disclosed herein are improvements to paging procedure, including: 1) Indication of multiple paging UE identities in the RRC paging message; 2) Use of different P-RNTI values for group-based paging; 3) Use of additional PDCCH monitoring occasions for the existing PO reserved for group-based paging; 4) Use of different search spaces for paging different types of UEs; and 5) Use of spare bits in paging DCI format for group indication or data type indication.

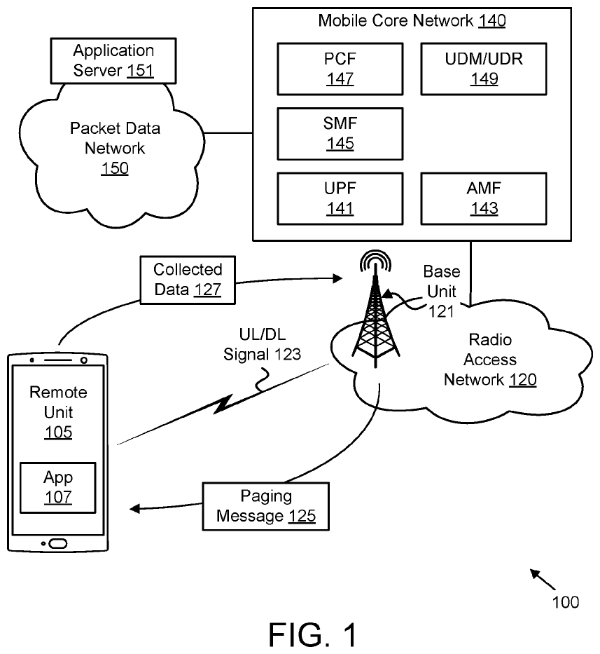

FIG. 1 depicts a wireless communication system 100 for retrieving data from a group of devices, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connections) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various embodiments, the remote unit 105 receives a paging message 125 to send collected data. As described in greater detail below, the paging message 125 may be sent to a group of remote unit 105. A remote unit 105 receiving the paging message 125 determines whether to establish a connection to the mobile core network 140 via the RAN 120 to send collected data 127.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM′”′) and a User Data Repository (“UDR”) 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for retrieving data from a group of devices apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB node” is used for the base station/base unit, but it is replaceable by any other radio access node, e.g., RAN node, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for retrieving data from a group of devices.

Real-time retrieval of data collected from a group of devices (e.g., remote units 105 or UEs) to control machines or other objects in real-time has been disclosed. In summary, the concept comprises the following solutions:

Solution 1: Multiple UE-specific ID allocation to support various group communication modes (or group operation modes). Here, each device is assigned by network to one or more group(s) of associated devices. As result of NAS registration procedure each device is allocated by network (e.g., AMF) with A) a temporary UE identity associated with each group communication mode (i.e., UE identification information for a particular group communication mode, e.g., 5G-GUTI, I-RNTI for a particular group communication mode), and B) a temporary UE identity associated with an individual communication mode, e.g., 5G-GUTI, I-RNTI for an individual communication mode. For power saving at the device, the AMF may ensure that the multiple temporary UE identities allocated to the device result in the same PFs and POs for paging.

Solution 2: Indication of a preferred communication mode (or group operation mode). Here, each device can be operated with either a group communication mode or an individual communication mode. Each device can indicate to network a preferred operation mode during the RRC connection (re)establishment or RRC resume procedures based on one or more device originated traffic types, e.g. in case of group communication mode: A) by setting an indication (e.g. “groupCommMode”) in the RRCSetupRequest, RRCReestablishmentRequest or RRCResumeRequest message; B) by selecting a specific SR or RACH resource; or C) by explicitly indicating a particular communication mode in MsgA PUSCH (in case of 2-step random access procedure) or Msg3 PUSCH (in case of 4-step random access procedure) during the random access to procedure.

Solution 3: Paging, UL timing alignment, and wake-up for group communication. For event-triggered group communication (e.g., event-triggered real-time data retrieval), one device's RRC connection establishment attempt may invoke RRC connection establishment procedures of other devices in the group of associated devices. That is, a network entity (e.g., AMF, gNB) initiates paging for the other devices in the group in response to reception of an RRC connection establishment request or an RRC resume request from the one device in the group. A UE ID from multiple assigned UE IDs to a UE, being associated with a particular communication mode, can be included in a paging record. In one example, the device may be a controller or an aggregator for the other devices in the group of associated devices.

Alternatively, the network entity may trigger PDCCH-order based random access procedures for other devices in the group that are not uplink synchronized (i.e., for which UL timing alignment timers expired and the device is in RRC_CONNECTED state) or the network entity may transmit a wake-up signal/channel to other devices in the group.

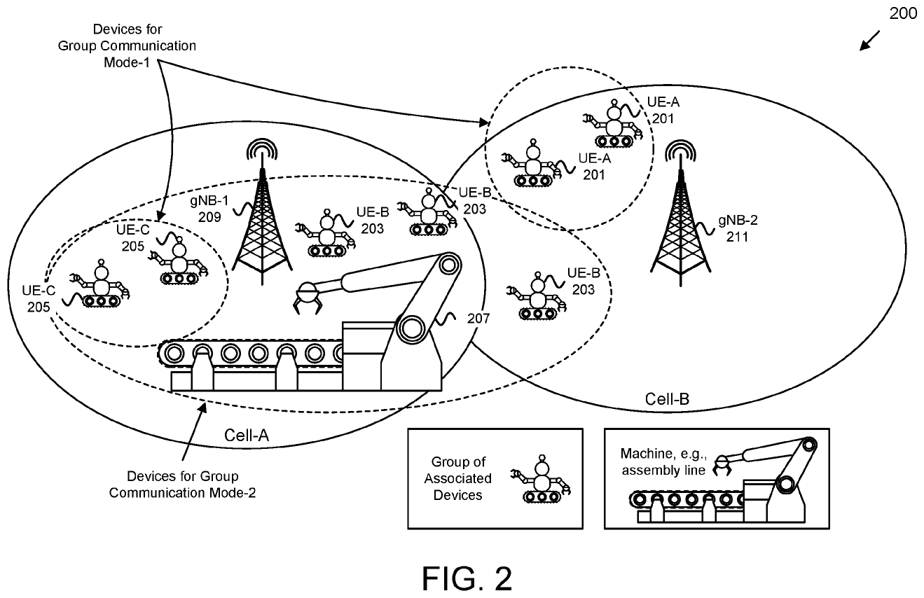

FIG. 2 illustrates an exemplary scenario 200 for retrieving data from a group of devices (e.g., wireless sensors, video surveillance cameras) where the devices are located in different cells (Cell-A, Cell-B) and assigned to two groups (Group Communication Mode-1, Group Communication Mode-2). As depicted, a first set of communication devices—denoted UE-A 201—belong only to Group Communication Mode-1, a first set of communication devices—denoted UE-B 203—belong only to Group Communication Mode-2, and a third set of communication devices—denoted UE-C 205—belong to both Group Communication Mode-1 and Group Communication Mode-2. A first gNB (denoted “gNB-1”) 209 supports Cell-A, while a second gNB (denoted “gNB-2”) 211 supports Cell-B.

The groups of communication devices generate a set of real-time control parameters for desired actions at the machine 207, e.g., an assembly line producing circuit boards for cellular phones. Note that the machine 207 may implement and/or include a remote unit 105. The set of control parameters may include temperature, pressure, humidity, motion, audio, and video data. The devices generate the set of control parameters by collecting data in the RRC states connected, idle, inactive in accordance with their configurations.

Described below are some modifications and enhancements to the concept of retrieval of data collected from a group of devices. To efficiently support retrieval of data collected from a group of devices, modifications and enhancements to existing messages and procedures as specified in 3GPP specifications are described.

In one embodiment, the RRC Paging message may be extended by following new parameters (see Table 1):
Paging cause that may be set to following value: {MO data retrieval}
Traffic type that may be set to following values: {temperature, pressure, humidity, motion, location, orientation, audio, video}

TABLE 1
RRC Paging message with extended content

| | | | IE type |
|---|---|---|---|
| IE/Group Name | Presence | Range | and reference |
| PagingRecordList | O | | |
| >PagingRecord | | 1 . . . | |
| | | <maxNrofPageRec> | |
| >>CHOICE | M | | |
| PagingUE-Identity | | | |
| >>>NG-5G-S-TMSI | | | BIT STRING |
| | | | (SIZE(48)) |
| >>>I-RNTI-Value | | | BIT STRING |
| | | | (SIZE(40)) |
| >>AccessType | O | | non3GPP |
| >>Paging cause | O | | |
| >>Traffic type | O | | |

In one embodiment, the NG Paging message may be extended by following new parameters (see Table 2):
Paging cause that may be set to following value: {MO data retrieval}
Traffic type that may be set to following values: {temperature, pressure, humidity, motion, location, orientation, audio, video}

TABLE 2
NG Paging message with extended content

| | | | IE type |
|---|---|---|---|
| | | | and 3GPP |
| IE/Group Name | Presence | Range | reference |
| Message Type | M | | 9.3.1.1 |
| UE Paging Identity | M | | 9.3.3.18 |
| Paging DRX | O | | 9.3.1.90 |
| TAI List for Paging | | 1 | |
| >TAI List for | | 1 . . . <maxnoofTAIforPaging> | |
| Paging Item | | | |
| >>TAI | M | | 9.3.3.11 |
| Paging Priority | O | | 9.3.1.78 |
| UE Radio Capability | O | | 9.3.1.68 |
| for Paging | | | |
| Paging Origin | O | | 9.3.3.22 |
| Assistance Data | O | | 9.3.1.69 |
| for Paging | | | |
| Paging cause | O | | |
| Traffic type | O | | |

In one embodiment, the Xn RAN Paging message may be extended by following new parameters (see also Table 3):
Paging cause that may be set to following value: {MO data retrieval}
Traffic type that may be set to following values: {temperature, pressure, humidity, motion, location, orientation, audio, video}

TABLE 3
Xn RAN Paging message with extended content

| | | | IE type and |
|---|---|---|---|
| IE/Group Name | Presence | Range | 3GPP reference |
| Message Type | M | | 9.2.3.1 |
| CHOICE UE Identity | M | | |
| Index Value | | | |
| >Length-10 | | | |
| >>Index Length-10 | M | | BIT STRING |
| | | | (SIZE(10)) |
| UE RAN Paging Identity | M | | 9.2.3.43 |
| Paging DRX | M | | 9.2.3.66 |
| RAN Paging Area | M | | 9.2.3.38 |
| Paging Priority | O | | 9.2.3.44 |
| Assistance Data for RAN Paging | O | | 9.2.3.41 |
| UE Radio Capability for Paging | O | | 9.2.3.91 |
| Paging cause | O | | |
| Traffic type | O | | |

In the above Tables 1, 2 and 3, the Presence Type ‘M’ indicates a mandatory IE, while the Presence Type ‘O’ indicates an optional IE. Note that in the above Tables 1, 2 and 3, the Paging cause and the Traffic type may be combined into a single parameter to indicate MO data retrieval and the type of MO data.

In certain embodiments, the NAS Service request and PDU session establishment request messages are extended by following new parameters:
Group communication mode identity
Traffic type that may be set to following values: {temperature, pressure, humidity, motion, location, orientation, audio, video}

In various embodiments, a new NG Paging request message is defined which contains the following parameters:
Group communication mode identity
Traffic type that may be set to following values: {temperature, pressure, humidity, motion, location, orientation, audio, video}

In some embodiments, to support retrieving data from a group of devices, new information may be transported on RRC indicating the type of data sent by the network to a UE, e.g., in a new MAC control element which is multiplexed either in the random access response (RAR) message (step 2 in 4-step RA type) or contention resolution message (step 4 in 4-step RA type or MsgB in 2-step RA type) during random access procedure or the new information indicating the data type is included in the UL grant in the RAR message.

In some embodiments, to support retrieving data from a group of devices, new information may be transported on RRC indicating the type of data sent by a UE to the network as a new cause value in UL RRC messages, e.g., RRCSetupRequest or RRCResumeRequest messages. Alternatively, such indication may be in a new MAC control element which is multiplexed either in the MsgA (in 2-step RA type) or in Msg3 (in 4-step RA type) during random access procedure.

In some embodiments, to support retrieving data from a group of devices, paging procedures may be improved by including an indication of multiple paging UE identities in the RRC paging message. Further, the paging procedure may be enhanced by use of different P-RNTI values for group-based paging, by use of additional PDCCH monitoring occasions for the existing PO reserved for group-based paging, by use of different search spaces for paging different types of UEs, and/or by use of spare bits in paging DCI format for group indication or data type indication.

According to embodiments of the first solution, an AMF may determine to page a group of UEs with a specific paging purpose. For event-triggered group communication (e.g., event-triggered real-time data retrieval), one device's RRC connection establishment for sending collected data in response to an event having been triggered, may invoke RRC connection establishment of other devices in the group of associated devices. That is, the AMF requests the paging of the other devices in the group in response to the establishment of an RRC connection from the one device in the group.

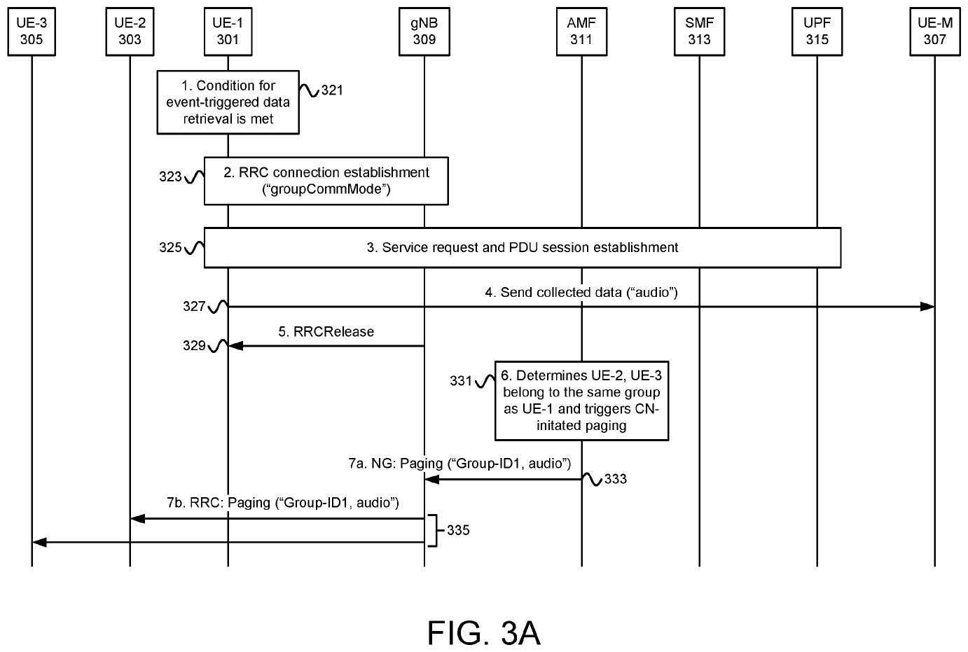

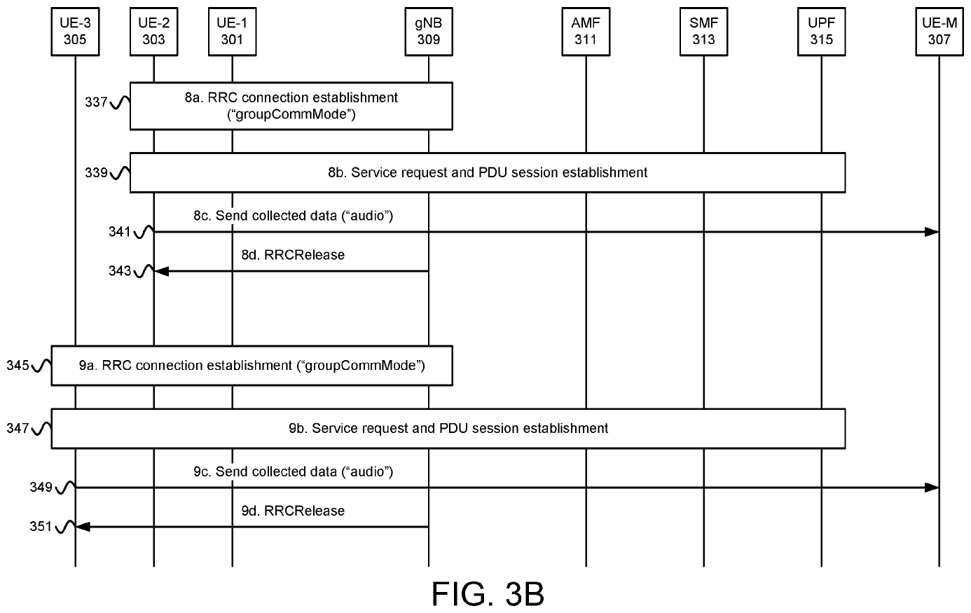

FIGS. 3A-3B show an exemplary message flow of a procedure 300 for event-triggered real-time data retrieval, according to embodiments of the disclosure. The procedure 300 involves three data-collecting communication devices, denoted as UE-1 301, UE-2 303, and UE-3 305. Each of the UE-1 301, UE-2 303, and UE-3 305 may be an embodiment of the remote unit 105. The procedure 300 also involves a gNB 309, an AMF 311, a SMF 313 and a UPF 315, which may be embodiments of the base unit 121, the AMF 143, the SMF 145, and the UPF 145, respectively. The gNB 309, AMF 311, SMF 313 and UPF 315 form a communication network.

For the procedure 300, it is assumed—as a precondition—that the UEs 301-305 are registered in the network and are assigned to the same group, denoted as Group Communication Mode-1. In this group communication mode, the UEs 301-305 are configured to collect at least one of the following types of data: {temperature, pressure, humidity, motion, location, orientation, audio, video}. Moreover, it is assumed that that all UEs 301-305 are in an idle state (i.e., RRC_IDLE in AS and 5GMM-IDLE in NAS) and are located in the same cell. A machine, e.g., assembly line, denoted as UE-M 307, is considered as recipient of the data collected from the UEs 301-305. Note that the UE-M 307 may be one embodiment of the machine 207. Here, the collected data may be used to generate a set of real-time control parameters for desired actions at the UE-M 307.

At Step 1, a condition for event-triggered data retrieval is met in the UE-1 301, e.g., “collected audio data reached maximum size” (see block 321).

At Step 2, the UE-1 301 performs an RRC connection establishment procedure between the UE-1 301 and its serving gNB 309 (see block 323). In the RRCSetupRequest message, the UE-1 301 sends its UE identity (e.g., 5G-S-TMSI) and the flag “groupCommMode” to indicate to the gNB 309 its preferred operation mode during the RRC connection establishment procedure.

At Step 3, after successful RRC connection establishment, the UE-1 301 performs a NAS Service request procedure and PDU session establishment procedure between the UE-1 301 and the concerned CN network entities (i.e., the AMF 311, the SMF 313, and the UPF 315) to establish user-plane resources for a PDU session that is to be used for sending the collected audio data to the UE-M 307 (see block 325). To specify the purpose of the service request procedure the UE-1 301 sends the Service Request message with the following settings to the AMF 311:
5G-S-TMSI set to “group communication mode-1 identity” (48-bits value)
Service type set to “data” (to indicate the purpose of the service request procedure)
Traffic type set to “audio”

Alternatively, at Step 3 the UE-1 301 may use the extended NAS service request message described above with the following settings in order to request the AMF to initiate paging to the other UEs of the group:
Group communication mode identity set to “group communication mode-1 identity” (48-bits value)
Traffic type set to “audio”

Furthermore, in another implementation the UE-1 301 in step 3 may use the extended NAS PDU session establishment request message with the following settings in order to request the AMF 311 to initiate paging to the other UEs of the group:
Group communication mode identity set to “group communication mode-1 identity” (48-bits value)
Traffic type set to “audio”

At Step 4, it is assumed that in step 3 both Service request and PDU session establishment procedures have been performed successfully, so that UE-1 301 sends its collected audio data to the UE-M 307 using the established radio and core network user-plane resources (see messaging 327).

At Step 5, after the successful transmission of the collected audio data, the gNB 309 releases the RRC connection and moves the UE-1 301 either to RRC_IDLE or RRC_INACTIVE state (see messaging 329).

At Step 6, based on the information received by the UE-1 301 in the Service Request message (i.e., the 5G-S-TMSI set to “group communication mode-1 identity”), the AMF 311 determines that the UE-2 303 and the UE-3 305 belong to the same group as the UE-1 301 (see block 331). Because both the UE-2 303 and the UE-3 305 are in RRC_IDLE/5GMM-IDLE state, the AMF 311 triggers a CN-initiated paging to the UE-2 303 and the UE-3 305. In another implementation, the AMF 311 may perform the determination of the other UEs in the group earlier than in step 6, e.g., performing the determination in step 3, prior to completion of the PDU session establishment.

At Step 7a, the AMF 311 sends on NG interface to the gNB 309 the Paging message for the UE-2 303 and the UE-3 305 (see messaging 333). In various embodiments, the NG paging message is according to Table 2, with the following settings:
UE Paging Identity set to “group communication mode-1 identity” (depicted as “Group-ID1”)
Paging DRX value set to 320 ms (DRX value configured for Group Communication Mode-1)
For Paging on the radio interface, a list of TAIs and optionally information on recommended cells
Paging cause set to “MO data retrieval”
Traffic type set to “audio” (as described above, the Paging cause and the Traffic type may be combined into a single parameter that jointly encodes “MO data retrieval” and the “audio” traffic type)

At Step 7b, upon the reception of the NG Paging message from the AMF 311, the gNB 309 performs paging of the UE-2 303 and the UE-3 305 in the cells which belong to tracking areas (“TAs”) as indicated in the TAI list and/or by the information on recommended cells (see messaging 335). Here, the gNB 309 sends the RRC Paging message to the UE-2 303 and UE-3 305 according to the information received from the AMF 311 (i.e., Paging DRX value, UE Paging Identity). In various embodiments, the RRC Paging message is according to Table 1, with one paging record set as follows:
UE-Identity set to “group communication mode-1 identity”
Paging cause set to “MO data retrieval”
Traffic type set to “audio” (as described above, the Paging cause and the Traffic type may be combined into a single parameter that jointly encodes “MO data retrieval” and the “audio” traffic type)

Continuing on FIG. 3B, the Steps 8a, b, c, d represent actions of the UE-2 303. Here, the UE-2 303 monitors the paging channels (i.e., monitors Physical Downlink Control Channel (“PDCCH”) containing P-RNTI and PDSCH containing the Paging message) in the respective PFs and POs per DRX cycle based on its allocated temporary identities (individual and group identities) and RRC Paging configuration in the serving cell, e.g., as specified in TS 38.331 and 38.304. Upon reception of the Paging message with matching identity (“group communication mode-1 identity”) in one paging record, the UE-2 303 performs the steps 8a, b, c, d.

At Step 8a, the UE-2 303 performs an RRC connection establishment procedure between the UE-2 303 and its serving gNB 309 (see block 337). In the RRCSetupRequest message, the UE-2 303 sends its UE identity (e.g., 5G-S-TMSI) and the flag “groupCommMode” to indicate to the gNB 309 its preferred operation mode during the RRC connection establishment procedure.

At Step 8b, after successful RRC connection establishment, the UE-2 303 performs a NAS Service request procedure and PDU session establishment procedure between the UE-2 303 and the concerned CN network entities (i.e., the AMF 311, the SMF 313, and the UPF 315) to establish user-plane resources for a PDU session that is to be used for sending the collected audio data to the UE-M 307 (see block 339). To specify the purpose of the service request procedure the UE-2 303 sends the Service Request message with the following settings to the AMF 311:
5G-S-TMSI set to “group communication mode-1 identity” (48-bits value)
Service type set to “data” (to indicate the purpose of the service request procedure)
Traffic type set to “audio”

Alternatively, at Step 8b the UE-2 303 may use the extended NAS service request message described above with the following settings in order to request the AMF to initiate paging to the other UEs of the group:
Group communication mode identity set to “group communication mode-1 identity” (48-bits value)
Traffic type set to “audio”

At Step 8c, it is assumed that in step 8b both Service request and PDU session establishment procedures have been performed successfully, so that UE-2 303 sends its collected audio data to the UE-M 307 using the established radio and core network user-plane resources (see messaging 341).

At Step 8d, after the successful transmission of the collected audio data, the gNB 309 releases the RRC connection and moves the UE-2 303 either to RRC_IDLE or RRC_INACTIVE state (see messaging 343).

Steps 9a, b, c, d represent actions of the UE-3 305. Note that Steps 9a, b, c, d may be performed by the UE-3 305 in parallel with the UE-2 303 performing Steps 8a, b, c, d.

The UE-3 305 monitors the paging channels (PDCCH containing P-RNTI and PDSCH containing the Paging message) in the respective PFs and POs per DRX cycle based on its allocated temporary identities (individual and group identities) and RRC Paging configuration in the serving cell, e.g., as specified in TS 38.331 and 38.304. Upon reception of the Paging message with matching identity (“group communication mode-1 identity”) in one paging record, the UE-3 305 performs the steps 9a, b, c, d.

At Step 9a, the UE-3 305 performs an RRC connection establishment procedure between the UE-3 305 and its serving gNB 309 (see block 345). In the RRCSetupRequest message, the UE-3 305 sends its UE identity (e.g., 5G-S-TMSI) and the flag “groupCommMode” to indicate to the gNB 309 its preferred operation mode during the RRC connection establishment procedure.

At Step 9b, after successful RRC connection establishment, the UE-3 305 performs a NAS Service request procedure and PDU session establishment procedure between the UE-3 305 and the concerned CN network entities (i.e., the AMF 311, the SMF 313, and the UPF 315) to establish user-plane resources for a PDU session that is to be used for sending the collected audio data to the UE-M 307 (see block 347). To specify the purpose of the service request procedure the UE-3 305 sends the Service Request message with the following settings to the AMF 311:
5G-S-TMSI set to “group communication mode-1 identity” (48-bits value)
Service type set to “data” (to indicate the purpose of the service request procedure)
Traffic type set to “audio”

Alternatively, at Step 9b the UE-3 305 may use the extended NAS service request message described above with the following settings in order to request the AMF to initiate paging to the other UEs of the group:
Group communication mode identity set to “group communication mode-1 identity” (48-bits value)
Traffic type set to “audio”

At Step 9c, it is assumed that in step 9b both Service request and PDU session establishment procedures have been performed successfully, so that UE-3 305 sends its collected audio data to the UE-M 307 using the established radio and core network user-plane resources (see messaging 349).

At Step 9d, after the successful transmission of the collected audio data, the gNB 309 releases the RRC connection and moves the UE-3 305 either to RRC_IDLE or RRC_INACTIVE state (see messaging 351).

For ease of illustration, only the key messages and procedure steps are shown in FIGS. 3A-3B in order to illustrate the principle of event-triggered real-time data retrieval. Details of the messages and procedures may be as described in 3GPP TS 38.331, 23.501, 23.502, 24.501, and 38.413.

According to embodiments of the second solution, a gNB may request an AMF to page a group of UEs with a specific paging purpose. For example, upon receiving a connection establishment request from a first UE of a group of associated UEs, the gNB may request the AMF to page group of UEs with specific paging purpose.

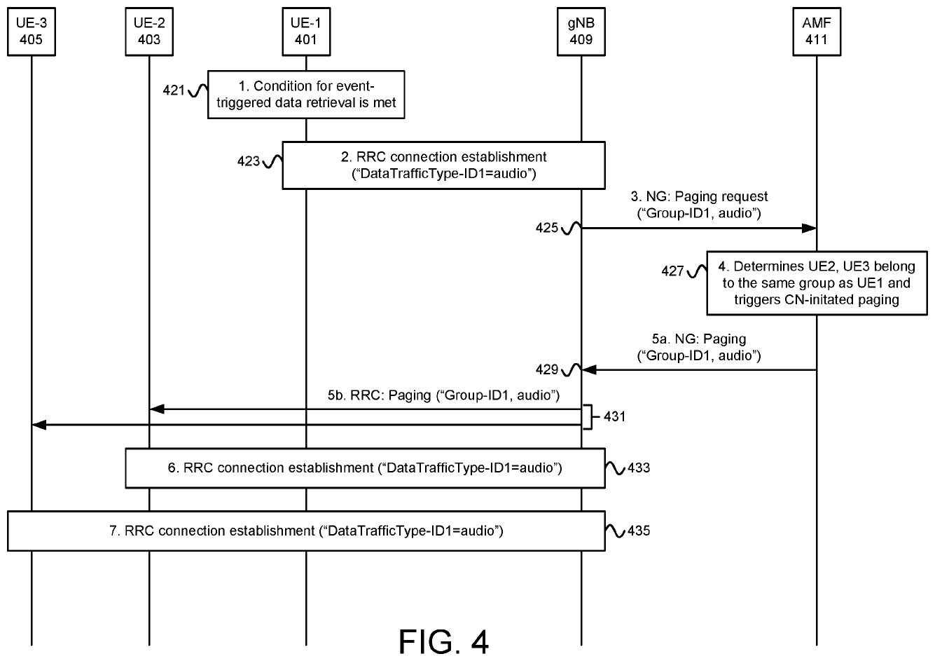

FIG. 4 shows an exemplary message flow of a procedure 400 for event-triggered real-time data retrieval, according to embodiments of the disclosure. The procedure 400 involves three data-collecting communication devices, denoted as UE-1 401, UE-2 403, and UE-3 405. Each of the UE-1 401, UE-2 403, and UE-3 405 may be an embodiment of the remote unit 105. The procedure 400 also involves a gNB 409 and an AMF 411, which may be embodiments of the base unit 121 and the AMF 143, respectively. The gNB 409 and AMF 411 are part of a communication network with which the UEs 401-405 can transmit collected data to a machine, such as the UE-M 307 and/or machine 207.

For the procedure 400, it is assumed—as a precondition—that the UEs 401-405 are registered in the network and are assigned to the same group, denoted as Group Communication Mode-1. In this group communication mode, the UEs 401-405 are configured to collect at least one of the following types of data: {temperature, pressure, humidity, motion, location, orientation, audio, video}. Moreover, it is assumed that that all UEs 401-405 are in an idle state (i.e., RRC_IDLE in AS and 5GMM-IDLE in NAS) and are located in the same cell.

At Step 1, a condition for event-triggered data retrieval is met in the UE-1 401, e.g., “collected audio data reached maximum size” (see block 421).

At Step 2, the UE-1 401 performs a RRC connection establishment procedure between the UE-1 401 and its serving gNB 409 (see block 423). The UE-1 401 includes its UE identity (i.e., 5G-S-TMSI) and a data traffic type identifier (e.g., ‘1’) identifying the audio type of collected data in the RRCSetupRequest message to indicate to the gNB 409 to activate the gNB-requested paging functionality.

In another example, the UE-1 401 may set the establishment cause in the RRCSetupRequest message to “mo-GroupDataType1” which is mapped to audio type of data. In a further example, the UE-1 401 is in RRC_CONNECTED state and indicates the data traffic type identifier ‘1’ based on a SR (e.g., data traffic type identifier ‘1’ mapped to a SR configuration) or included the indication in a BSR MAC CE or in a new MAC CE transmitted in the PUSCH comprising the BSR MAC CE.

At Step 3, based on the information received from the UE-1401, the gNB 409 sends the NG Paging request message to the AMF 411 which includes the Group Communication Mode-1 identity to which the UE-1 401 belongs (depicted as “Group-ID1”) and the traffic type set to “audio” (see messaging 425). It is assumed that the gNB 409 has knowledge of all the groups of UEs configured in the network.

At Step 4, based on the information received from the gNB 409, the AMF 411 determines that the UE-2 403 and the UE-3 405 belong to the same group as the UE-1 401 (see block 427). Because both the UE-2 403 and the UE-3 405 are in RRC_IDLE/5GMM-IDLE state, the AMF 411 triggers a CN-initiated paging to the UE-2 403 and the UE-3 405.

At Step 5a, the AMF 411 sends on the NG interface to the gNB 409 the Paging message for the UE-2 403 and the UE-3 405 (see messaging 429). In various embodiments, the NG paging message is according to Table 2, with following settings:
UE Paging Identity set to “group communication mode-1 identity”
Paging DRX value set to 320 ms (DRX value configured for Group Communication Mode-1)
For Paging on the radio interface, a list of TAIs and optionally information on recommended cells
Paging cause set to “MO data retrieval”
Traffic type set to “audio” (as described above, the Paging cause and the Traffic type may be combined into a single parameter that jointly encodes “MO data retrieval” and the “audio” traffic type)

At Step 5b, upon the reception of the NG Paging message from the AMF 411, the gNB 409 performs paging of the UE-2 403 and the UE-3 405 in the cells which belong to tracking areas as indicated in the TAI list and/or by the information on recommended cells (see messaging 431). The gNB 409 sends the RRC Paging message to the UE-2 403 and UE-3 405 according to the information received from the AMF 411 (i.e., Paging DRX value, UE Paging Identity). In various embodiments, the RRC Paging message is according to Table 1, with one paging record set as follows:
UE-Identity set to “group communication mode-1 identity”
Paging cause set to “MO data retrieval”
Traffic type set to “audio” (as described above, the Paging cause and the Traffic type may be combined into a single parameter that jointly encodes “MO data retrieval” and the “audio” traffic type)

The UE-2 403 and UE-3 405 monitor the paging channels (PDCCH containing P-RNTI and PDSCH containing the Paging message) in the respective PFs and POs per DRX cycle based on its allocated temporary identities (individual and group identities) and RRC Paging configuration in the serving cell, e.g., as specified in 3GPP TS 38.331 and 38.304.

At Step 6, the UE-2 403, upon reception of the Paging message with matching identity (“Group Communication Mode-1 identity”) in one paging record, performs the RRC connection establishment procedure between the UE-2 403 and its serving gNB 409 (see block 433). The UE-2 403 includes its UE identity (5G-S-TMSI) and a data traffic type identifier (e.g., ‘1’) identifying the audio type of collected data in the RRCSetupRequest message to indicate to the gNB 409 to establish a connection to send collected data.

At Step 7, the UE-3 405, upon reception of the Paging message with matching identity (“Group Communication Mode-1 identity”) in one paging record, the UE-3 405 performs the RRC connection establishment procedure between the UE-3 405 and its serving gNB 409 (see block 435). The UE-3 405 includes its UE identity (5G-S-TMSI) and a data traffic type identifier (e.g., ‘1’) identifying the audio type of collected data in the RRCSetupRequest message to indicate to the gNB 409 to establish a connection to send collected data.

The main advantage of gNB-requested paging is that the AMF 411 is able to initiate paging more quickly to group of UEs, i.e., prior to performing the NAS Service request and PDU session establishment procedures by UE-1 401.

For ease of illustration, only the key messages and procedure steps are shown in FIG. 4 in order to illustrate the principle of event-triggered real-time data retrieval. Details of the messages and procedures may be as described in 3GPP TS 38.331, 23.501, 23.502, 24.501, and 38.413.

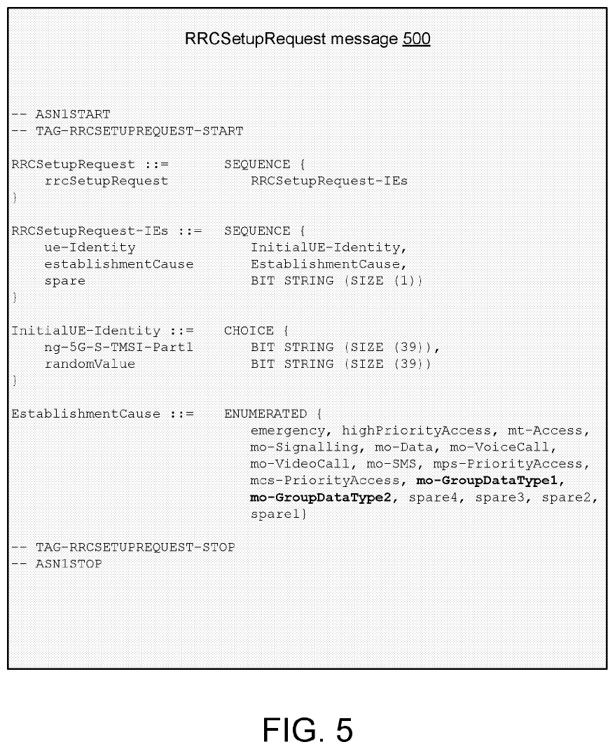

FIG. 5 depicts an example of an RRCSetupRequest message, e.g., as used with Steps 2, 6 and 7 of FIG. 4.

According to embodiments of the third solution, a gNB may request another gNB to page a group of UEs with a specific paging purpose. For example, upon receiving a NG paging message, the gNB may request another gNB to page group of UEs with specific paging purpose.

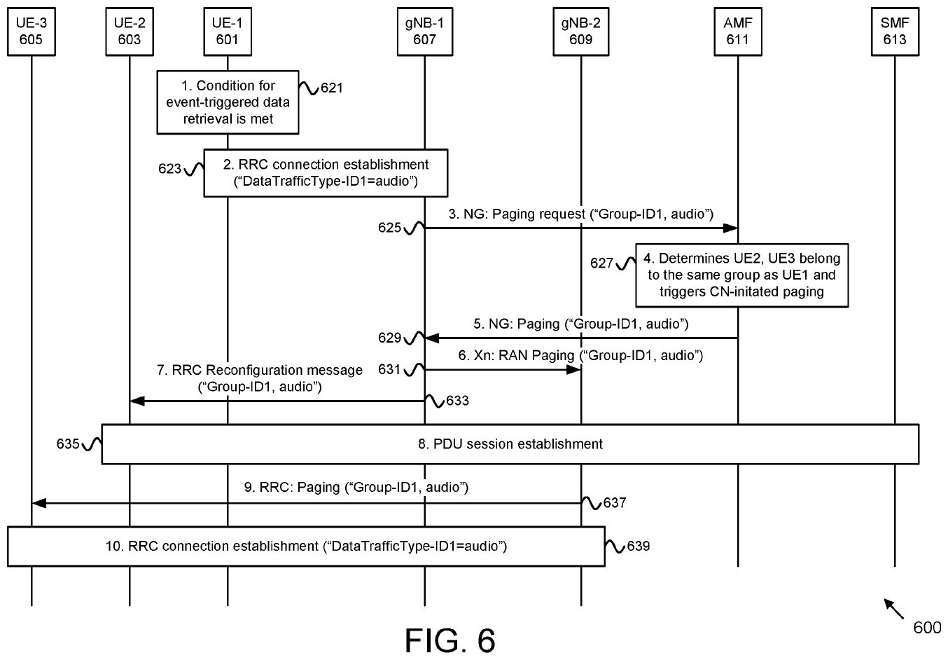

FIG. 6 depicts an exemplary message flow of a procedure 600 for event-triggered real-time data retrieval, according to embodiments of the disclosure. The procedure 600 involves three data-collecting communication devices, denoted as UE-1 601, UE-2 603, and UE-3 605. Each of the UE-1 601, UE-2 603, and UE-3 605 may be an embodiment of the remote unit 105. The procedure 600 also involves a first gNB (denoted as “gNB-1”) 607, a second gNB (denoted as “gNB-2”) 609, and an AMF 611, which may be embodiments of the base unit 121 and the AMF 143, respectively. The gNBs 607-609 and AMF 611 are part of a communication network with which the UEs 601-605 can transmit collected data to a machine, such as the UE-M 307 and/or machine 207.

For the procedure 600, it is assumed that the UEs are in different RRC states. Additionally, the description of FIG. 6 is based on following assumptions:
3 data collection devices are considered (i.e., UE-1 601, UE-2 603, UE-3 605).
The UE-1 601 is in idle state (i.e., RRC_IDLE in AS and 5GMM-IDLE in NAS) and is located in the cell served by the gNB-1 607.
The UE-2 603 is in connected state (i.e., RRC_CONNECTED in AS and 5GMM-CONNECTED in NAS) and is located in the cell served by the gNB-1 607.
The UE-3 605 is in inactive state (i.e., RRC_INACTIVE in AS and 5GMM-CONNECTED in NAS) and is located in the cell served by the gNB-2 609. It is assumed that the UE-3 605 was previously located in a cell served by the gNB-1 607 and moved by the gNB-1 607 from connected to inactive state.
All UEs 601-605 are registered in the network and are assigned to the same group denoted as group communication mode-1. In this group communication mode, the UEs 601-605 are configured to collect at least one of the following types of data: {temperature, pressure, humidity, motion, location, orientation, audio, video}

At Step 1, a condition for event-triggered data retrieval is met in the UE-1 601, e.g., “collected audio data reached maximum size” (see block 621).

At Step 2, the UE-1 601 performs a RRC connection establishment procedure between the UE-1 601 and its serving gNB-1 607 (see block 623). The UE-1 601 includes its UE identity (i.e., 5G-S-TMSI) and a data traffic type identifier (e.g., ‘1’) identifying the audio type of collected data in the RRCSetupRequest message to indicate to the gNB-1 607 to activate the gNB-requested paging functionality.

At Step 3, based on the information received from the UE-1 601, the gNB-1 607 sends the NG Paging request message to AMF 611 which includes the Group Communication Mode-1 identity to which the UE-1 601 belongs (depicted as “Group-ID1”) and the traffic type set to “audio” (see messaging 625). It is assumed that the gNB-1 607 has knowledge of all groups of UEs configured in the network.

At Step 4, based on the information received from the gNB-1 607, the AMF 611 determines that the UE-2 603 and the UE-3 605 belong to the same group as the UE-1 601 and triggers a CN-initiated paging to the UE-2 603 and the UE-3 605 (see block 627).

At Step 5, the AMF 611 sends on NG interface to the gNB-1 607 the Paging message for the UE-2 603 and the UE-3 605 (see messaging 629). In various embodiments, the NG paging message is according to Table 2, with the following settings:
UE Paging Identity set to “group communication mode-1 identity”
Paging DRX value set to 320 ms (DRX value configured for group communication mode-1)
For Paging on the radio interface, a list of TAIs and optionally information on recommended cells
Paging cause set to “MO data retrieval”
Traffic type set to “audio” (as described above, for the NG Paging message, the Paging cause and the Traffic type may be combined into a single parameter that jointly encodes “MO data retrieval” and the “audio” traffic type)

At Step 6, upon the reception of the NG Paging message from the AMF 611, the gNB-1 607 determines that UE-3 605 is in inactive state. Therefore, it sends the Xn RAN paging message to all RAN nodes (including the gNB-2 609) of the RAN notification area to request paging of UE-3 605 by the other RAN nodes (see messaging 631). In various embodiments, the Xn RAN paging message is according to Table 3, with the following settings:
UE RAN Paging Identity set to “I-RNTI” (UE-3 605 identity in inactive state)
Paging cause set to “MO data retrieval”
Traffic type set to “audio” (as described above, for the Xn RAN paging message, the Paging cause and the Traffic type may be combined into a single parameter that jointly encodes “MO data retrieval” and the “audio” traffic type)

At Step 7, upon the reception of the NG Paging message from the AMF 611 in step 5, the gNB-1 607 determines that the UE-2 603 is in connected state and located in the cell served by the gNB-1 607. Therefore, it sends the RRC reconfiguration message to the UE-2 603 (see messaging 633) and by setting the message as follows:
UE-Identity set to “group communication mode-1 identity”
Traffic type set to “audio”

At Step 8, the UE-2 603 initiates PDU session establishment procedure to establish user-plane resources for a PDU session that is to be used for sending the collected audio data (see block 635).

At Step 9, upon the reception of the Xn RAN Paging message from the gNB-1 607, the gNB-2 609 performs paging of the UE-3 605 in its served cells which belong to RAN notification area (see messaging 637). The gNB-2 609 sends the RRC Paging message to the UE-3 605 according to the information received from gNB-1 607 and by setting one paging record as follows:
UE-Identity set to “I-RNTI” (UE-3 605 identity in inactive state)
Paging cause set to “MO data retrieval”
Traffic type set to “audio” (as described above, for the RRC Paging message, the Paging cause and the Traffic type may be combined into a single parameter that jointly encodes “MO data retrieval” and the “audio” traffic type)

At Step 10, the UE-3 605 monitors the paging channels (PDCCH containing P-RNTI and PDSCH containing the Paging message) in the respective PFs and POs per DRX cycle based on its allocated temporary identities (individual and group identities) and RRC Paging configuration in the camped cell served by gNB-2 609. Upon reception of the Paging message with matching identity (“I-RNTI”) in one paging record, the UE-3 605 performs the RRC connection establishment procedure between the UE-3 605 and its serving gNB-2 609 (see block 639). The UE-3 605 includes its UE identity (5G-S-TMSI) and a data traffic type identifier (e.g., ‘1’) identifying the audio type of collected data in the RRCSetupRequest message to indicate to the gNB-2 609 to establish a connection to send collected data.

For ease of illustration, only the key messages and procedure steps are shown in FIG. 6 in order to illustrate the principle of event-triggered real-time data retrieval. Details of the messages and procedures may be as described in 3GPP TS 38.331, 23.501, 23.502, 24.501, and 38.413.

According to embodiments of the fourth solution, a gNB may activate a certain UE (i.e., comprising—or co-located with—a measurement device and/or sensor) to send specific data during a Random Access Channel (“RACH”) procedure, following a legacy paging procedure. In various embodiments, the type of collected data to be provided by a device/sensor/UE is indicated within the random access procedure. In some embodiments, for the 4-step contention-based random access procedure during RRC connection establishment, one device's RRC connection attempt, e.g., sending collected data in response to an event having been triggered, may invoke the retrieval of collected data from other devices in the group of associated devices by e.g., paging such other devices.

The network should have the possibility to activate a specific functionality within the devices of a group, e.g., only activating a specific data type (i.e., the device should only provide audio data in response to the paging even though there might be also other data such as video data available). According to one implementation of the fourth solution, the network indicates within the random access procedure, which is e.g., performed in response to the reception of a paging message, which type of data the device/sensor/UE should provide, e.g. {temperature, pressure, humidity, motion, location, orientation, audio, video}.

According to one specific implementation of the fourth solution, the random access response (“RAR”) message (step 2 in 4-step RA type) includes an information indicating the type of data to be provided by the device/sensor/UE. Such information may be transmitted within the random access response MAC PDU message sent on PDSCH. A new MAC control element which is multiplexed in the RAR may contain the data traffic type. Alternatively, the data traffic type information may be signaled within the UL grant information sent within the RAR.

According to another implementation of the fourth solution, the data traffic type information is signaled within the contention resolution message (step 4 in 4-step RA type or MsgB in 2-step RA type), e.g., a new MAC control element comprised of the data traffic type is multiplexed in the contention resolution message. Alternatively, the data traffic type information may be signaled within the DL assignment DCI information scheduling the contention resolution message.

According to yet another implementation of the fourth solution, a UL DCI scheduling PUSCH following completion of the RACH procedure may contain a data traffic type information indicating which type of data to be sent on the allocated uplink resources.

According to embodiments of the fifth solution, paging procedures may be extended to support specific type of data retrieval from a group of devices. In order to support such group-based paging for data retrieval, the following options (or combination thereof) may be implemented by a communication network.

In some embodiments, multiple paging UE identities (PagingUE-Identity) may be configured for various data types, e.g., one for audio, one for video. Here, the Paging Frame and Paging Occasion (“PF/PO”) may be determined based on 5G S-TMSI. Therefore, no additional paging occasions are needed for a device. However, in the paging message the new PagingUE-Identities indicate the group identity (i.e., group radio network temporary identifier (“G-RNTI”)) and the type of data to be provided (e.g., audio, video) as shown in Table 4 below.

TABLE 4
Extension of the RRC Paging message

| | | | IE type and |
|---|---|---|---|
| IE/Group Name | Presence | Range | reference |
| PagingRecordList | O | | |
| >PagingRecord | | 1 . . . <maxNrofPageRec> | |
| >>CHOICE | M | | |
| PagingUE-Identity | | | |
| >>>NG-5G-S-TMSI | | | BIT STRING |
| | | | (SIZE(48)) |
| >>>I-RNTI-Value | | | BIT STRING |
| | | | (SIZE(40)) |
| >>>G-RNTI-Value | | | BIT STRING |
| 1 (camera, | | | (SIZE(X)) |
| video + audio) | | | |
| >>>G-RNTI-Value2 | | | BIT STRING |
| (camera, video) | | | (SIZE(X)) |
| >>AccessType | P | | non3GPP |

In some embodiments, different P-RNTI value(s) may be configured, e.g., with separate RNTI(s) for group-based paging. Here, the PF/PO are still calculated based on 5G S-TMSI. Therefore, from power consumption point of view there is no additional power consumption (i.e., a UE needs to decode the PDCCH to see whether RNTI matches with the RNTI scrambled with the DCI CRC). In legacy paging procedure, all UEs share a common P-RNTI to monitor paging DCI.

If multiple P-RNTIs are introduced and assigned to UEs in an efficient way, then UEs sharing a common paging occasion can use different P-RNTIs to monitor and receive their own paging messages. For example, different type of UEs like (reduced capability) sensors and surveillance cameras may be assigned a different P-RNTI.

In some embodiments, different paging message format may be used for the group-based paging. Here, the paging message itself could indicate the type of data to be provided by the group of UEs addressed within the paging message.

In some embodiments, additional PDCCH monitoring occasions for the existing PO may be reserved for group-based paging (similar to operation of NR devices in Unlicensed Spectrum). Here, separate additional PDCCH monitoring occasion within a PO may be used for group paging in order to minimize the additional power consumption (compared to monitoring additional POs). With the increase of PDCCH monitoring occasions, more paging transmission opportunities are provided to gNB for individual paging and group-based paging within one PO.

New paging UE identities (PagingUE-Identity) in the paging message may indicate the group identity and the type of data to be provided (e.g., camera audio, camera video). In order to reduce UE power consumption, some enhancement can be considered (e.g., the UE may stop monitoring the additional PDCCH monitoring occasion once it receives a page, i.e., only one paging for a UE within one PO).

In some embodiments, different search spaces may be used for paging different types of UEs like sensors, cameras, etc.

In some embodiments, some reserved or spare bits in the Paging DCI may be used to indicate further information like, e.g., group specific information like short group ID, see Table 5 below.

TABLE 5
DCI format used to schedule Paging messages

| Field (Item) | Bits | Reference |
|---|---|---|
| Short Message Indicator | 2 | See Table 7 below |
| Short Messages | 8 | See Table 8 below |
| Frequency domain resource assignment | Variable | |
| Time domain resource assignment | 4 | |
| VRB-to-PRB mapping | 1 | |
| Modulation and coding scheme | 5 | |
| TB Scaling | 2 | |
| Reserved | 6 | |

In some embodiments, UE grouping information may be indicated by the current paging PDCCH. If the UE is not in the indicated group signaled within the Paging PDCCH, such UE can skip the paging monitoring, which reduces the unnecessary paging PDSCH reception. There are several reserved bits (i.e., 11 bits comprising of 6 bits in paging DCI format and 5 bits in Short Messages) in paging PDCCH and some of them can be used to indicate UE grouping information. For example, if 3 of the reserved bits in paging PDCCH are used to indicate the UE grouping information, there can be 7 groups addressed. Only the UEs whose group is paged needs e.g., to receive paging message. Optionally the paging message may indicate what type of data the paged UEs have to provide to the network in response to the received paging. One mapping design for the group is shown in the Table 6 below.

TABLE 6
Group indication by paging DCI/PDCCH

| Indication in paging PDCCH | Paged UE Group |
|---|---|
| 0 | None of any UE group is |
| | paged (legacy paging) |
| 1 | Only UE Group1 is paged |
| 2 | Only UE Group2 is paged |
| 3 | Only UE Group3 is paged |
| . . . | . . . |
| 6 | Only UE Group6 is paged |
| 7 | Only UE group7 is paged |

In another example, the paging DCI may indicate information about the type of data the paged UEs have to provide to the network.

In some embodiments, Short Message may be used for group-based paging to inform the data type for retrieval. Short Messages can be transmitted on PDCCH using P-RNTI with or without associated Paging message using Short Message field in paging DCI format, see Table 7 below. Table 8 shows the Short Message bitmap. Bit 1 is the most significant bit. For example, the current spare bits 4-8 may be used to indicate to the UEs which are paged, i.e., the type of UE identity included in the paging message, what type of data the UE shall provide to the network. When the reserved bits are used to indicate UE grouping information, the 3 most significant bits are set to 0 for this purpose. Note that bits 4-8 are reserved bits that would typically be ignored by a legacy UE. However, the fifth solution utilizes these bits to indicate UE grouping information, as described above. Therefore, the UE may be configured to not ignore the reserved bits in paging DCI format and/or in Short Messages.

TABLE 7
Short Message Indicator

| Bit Field | Short Message Indicator |
|---|---|
| 00 | Reserved |
| 01 | Only scheduling information for Paging is present in the DCI |
| 10 | Only short message is present in the DCI |
| 11 | Both scheduling information for Paging and |
| | short message are present in the DCI |

TABLE 8
Short Message

| Bit | Short Message |
|---|---|
| 1 | systemInfoModification |
| | If set to 1: indication of a BCCH modification |
| | other than SIB6, SIB7 and SIB8. |
| 2 | etwsAndCmasIndication |
| | If set to 1: indication of an ETWS primary notification |
| | and/or an ETWS secondary notification |
| | and/or a CMAS notification. |
| 3 | stopPagingMonitoring |
| | This bit can be used for operation with shared |
| | spectrum channel access if nrofPDCCH- |
| | MonitoringOccasionPerSSB-InPO is present. |
| | If set to 1: indication that the UE may stop monitoring |
| | PDCCH occasion(s) for paging in this |
| | Paging Occasion as specified in TS 38.304. |
| 4-8 | Not used currently and will be ignored by legacy UE, if received. |

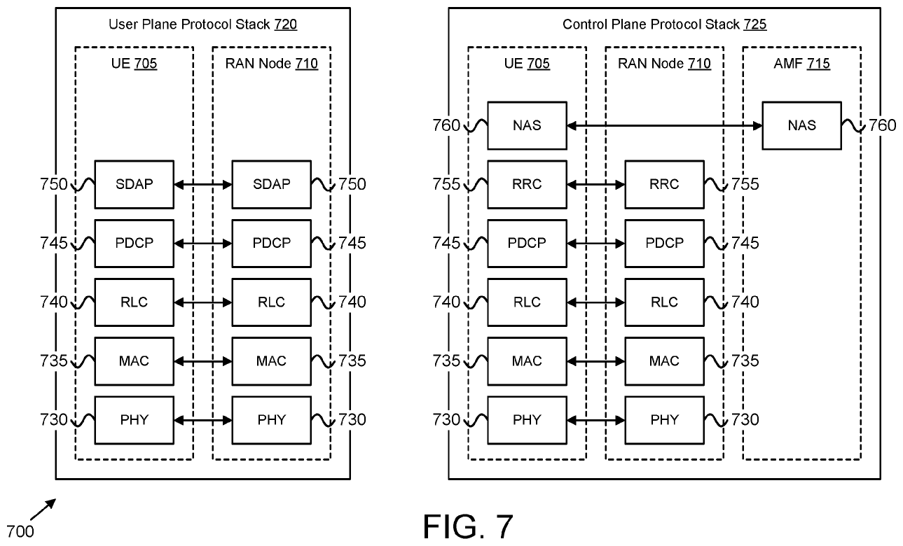

FIG. 7 depicts a NR protocol stack 700, according to embodiments of the disclosure. While FIG. 7 shows the UE 705, the RAN node 710 and an AMF 715 in a 5G core network (“5GC”), these are representative of a set of remote units 105 interacting with a base unit 121 and a mobile core network 140. Consequently, the UE 705 may be one embodiment of the remote unit 105, the UE-A 201, the UE-B 203, the UE-C 205, the first UE 301, the second UE 303, the third UE 305, the first UE 401, the second UE 403, the third UE 405, the first UE 601, the second UE 603, and/or the third UE 605. The RAN node 710 may be one embodiment of the base unit 121, the first gNB 209, the second gNB 211, the gNB 309, the gNB 409, the first gNB 607, and/or the second gNB 609. The AMF 715 may be one embodiment of the AMF 143, the AMF 311, the AMF 411, and/or the AMF 611.

As depicted, the protocol stack 700 comprises a User Plane protocol stack 720 and a Control Plane protocol stack 725. The User Plane protocol stack 720 includes a physical (“PHY”) layer 730, a Medium Access Control (“MAC”) sublayer 735, the Radio Link Control (“RLC”) sublayer 740, a Packet Data Convergence Protocol (“PDCP”) sublayer 745, and Service Data Adaptation Protocol (“SDAP”) layer 750. The Control Plane protocol stack 725 includes a physical layer 730, a MAC sublayer 735, a RLC sublayer 740, and a PDCP sublayer 745. The Control Plane protocol stack 725 also includes a Radio Resource Control (“RRC”) layer 755 and a Non-Access Stratum (“NAS”) layer 760.

The AS layer (also referred to as “AS protocol stack”) for the User Plane protocol stack 720 consists of at least SDAP, PDCP, RLC and MAC sublayers, and the physical layer. The AS layer for the Control Plane protocol stack 725 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 755 and the NAS layer 760 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 730 offers transport channels to the MAC sublayer 735. The physical layer 730 may perform a Clear Channel Assessment and/or Listen-Before-Talk (“CCA/LBT”) procedure using energy detection thresholds, as described herein. In certain embodiments, the physical layer 730 may send a notification of UL Listen-Before-Talk (“LBT”) failure to a MAC entity at the MAC sublayer 735. The MAC sublayer 735 offers logical channels to the RLC sublayer 740. The RLC sublayer 740 offers RLC channels to the PDCP sublayer 745. The PDCP sublayer 745 offers radio bearers to the SDAP sublayer 750 and/or RRC layer 755. The SDAP sublayer 750 offers QoS flows to the core network (e.g., 5GC). The RRC layer 755 manages the addition, modification, and release of Carrier Aggregation and/or Dual Connectivity. The RRC layer 755 also manages the establishment, configuration, maintenance, and release of Signaling Radio Bearers (“SRBs”) and Data Radio Bearers (“DRBs”).

The NAS layer 760 is between the UE 705 and the 5GC (i.e., AMF 715). NAS messages are passed transparently through the RAN. The NAS layer 760 is used to manage the establishment of communication sessions and for maintaining continuous communications with the UE 705 as it moves between different cells of the RAN. In contrast, the AS layer is between the UE 705 and the RAN (i.e., RAN node 710) and carries information over the wireless portion of the network.

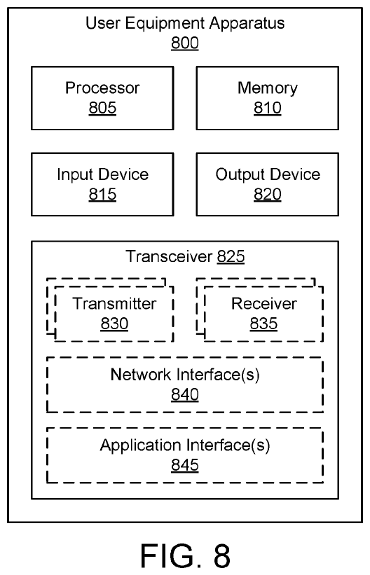

FIG. 8 depicts a user equipment apparatus 800 that may be used for retrieving data from a group of devices, according to embodiments of the disclosure. In various embodiments, the user equipment apparatus 800 is used to implement one or more of the solutions described above. The user equipment apparatus 800 may be one embodiment of the remote unit 105, the UE-A 201, the UE-B 203, the UE-C 205, the first UE 301, the second UE 303, the third UE 305, the first UE 401, the second UE 403, the third UE 405, the first UE 601, the second UE 603, the third UE 605, and/or the UE 705, described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above described UE behaviors. In certain embodiments, the processor 805 may include an application processor (also known as “main processor”) which manages application-domain and operating system (“OS”) functions and a baseband processor (also known as “baseband radio processor”) which manages radio functions.

In various embodiments, the processor 805 collects data in accordance with configuration received from an application function and determines that a condition for event-triggered data retrieval is met. The transceiver 825 (e.g., implementing a radio interface) transmits a first request message to a network entity (e.g., a RAN node or gNB) with information requesting the establishment of resources to send collected data. In one embodiment, the first message is a NAS service request message sent to an AMF via the network entity. In another embodiment, the first message is an RRC setup request message for establishing an RRC connection with the network entity.

Additionally, the transceiver 825 may receive a RRC paging message from the network entity with information requesting the establishment of connection to send collected data. In response to receiving the RRC paging message, the processor 805 determines whether to request establishment of connection to send collected data in accordance with the received RRC paging message.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to retrieving data from a group of devices and/or mobile operation. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and also to receive messages, data, and other signals. For example, the processor 805 may selectively activate the transceiver 825 (or portions thereof) at particular times in order to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

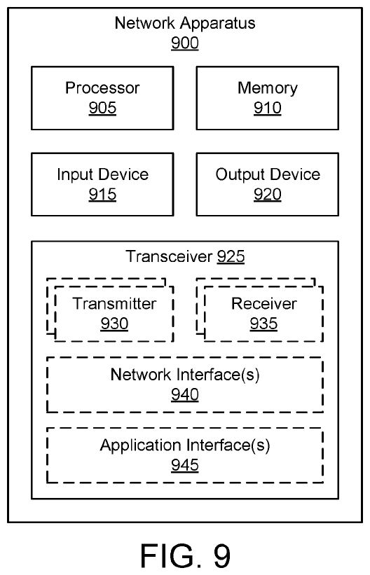

FIG. 9 depicts a network apparatus 900 that may be used for retrieving data from a group of devices, according to embodiments of the disclosure. In one embodiment, network apparatus 900 may be one implementation of a RAN entity, such as the base unit 121, the first gNB 209, the second gNB 211, the gNB 309, the gNB 409, the first gNB 607, the second gNB 609, and/or the RAN node 710, as described above. In another embodiment, the network apparatus 900 may be one implementation of a core network entity, such as the AMF 143, the AMF 311, the AMF 411, the AMF 611, and/or the AMF 715. Furthermore, the base network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

When performing RAN functions, a first implementation of the transceiver 925 (e.g., implementing a radio interface) may receive a first request message from a first UE requesting the establishment of resources to send collected data. In response, the processor 905 determines a group communication mode from the first request message. Moreover, a second implementation of the transceiver 925 (e.g., implementing a network interface) sends a message to a core network entity (e.g., AMF) with information requesting to page a group of UEs and receives a first paging message from the core network entity with information for paging the group of UEs to transfer collected data. In response to the first paging message, the first transceiver transmits a RRC paging message to the group of UEs requesting the establishment of resources to send the collected data.

In some embodiments, transmitting the message to the core network entity comprises sending a paging request in response to determining the group communication mode. In certain embodiments, the paging request comprises a first group communication mode identity, where a UE identity parameter of the RRC paging message is set to the first group communication mode identity.

In some embodiments, receiving the first paging message comprises receiving an NG paging message from an AMF associated with the first UE. In certain embodiments, the NG paging message comprises a paging cause value that indicates a MO data retrieval. In certain embodiments, the NG paging message further indicates a first traffic type included in the first request message. In one embodiment, the paging cause value jointly encodes MO data retrieval and the first traffic type.

In some embodiments, the second transceiver further sends a RAN paging message to at least one second RAN entity in response to receiving the first paging message from the core network entity. In such embodiments, the at least one second RAN entity is part of a RAN notification area associated with a non-connected UE (e.g., in IDLE state or INACTIVE state) of the group of UEs.

In certain embodiments, the RAN paging message comprises a paging cause value that indicates a MO data retrieval. In certain embodiments, the RAN paging message further indicates a first traffic type included in the first request message. In one embodiment, the paging cause value jointly encodes MO data retrieval and the first traffic type.

In some embodiments, the processor 905 further performs an RRC connection establishment procedure with at least one second UE of the group of UEs. In such embodiments, the first transceiver further receives collected data from the at least one second UE. In one embodiment, the first transceiver and second transceiver are logically separate transceivers which share communication resources. In other embodiments, the first transceiver and second transceiver comprise physically separate transceiver hardware.

In various embodiments, the processor 905 controls the apparatus 900 to perform the AMF behaviors described herein. In such embodiments, the transceiver 925 (e.g., implementing a network interface) receives a first request message indicating a group communication mode of a first UE. The processor 905 identifies a group of second UEs associated with the first request message and controls the transceiver 925 to send a paging message (i.e., CN-initiated paging) to the identified group to transfer collected data. Note that this paging message is sent to the identified group via a serving RAN entity (i.e., gNB).

The transceiver 925 further receives at least one second request message from at least one second UE of the identified group and the processor 905 establishes a data connection with each of the at least one second UE to receive the collected data.

In some embodiments, sending the paging message to the identified group comprises sending a NG paging message to at least one RAN node associated with a second UE. In such embodiments, the NG paging message comprises a paging cause value that indicates a MO data retrieval. In certain embodiments, the NG paging message further indicates a first traffic type included in the first request message. In one embodiment, the paging cause value jointly encodes MO data retrieval and the first traffic type.

In some embodiments, the first request message comprises a first group communication mode identity. In such embodiments, a UE identity parameter of the NG paging message is set to the first group communication mode identity. In some embodiments, the second request message comprises a first group communication mode identity included in the first request message.

In some embodiments, at least one second UE is in a non-connected state (e.g., in IDLE state or INACTIVE state) when the first request message is received. In some embodiments, establishing a data connection with a second UE comprises receiving (e.g., at the AMF) a PDU Session Establishment request message, said request message comprising at least one of: a first group communication mode identity included in the first request message and a first traffic type included in the first request message.

In some embodiments, the first request message comprises a service request message from the first UE. In some embodiments, the first request message comprises a paging request received from a RAN node serving the first UE.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to retrieving data from a group of devices. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to provide DL communication signals to a remote unit 105 and one or more receivers 935 may be used to receive UL communication signals from a remote unit 105, as described herein. Similarly, one or more transmitters 930 and one or more receivers 935 may be used to communicate with network functions in the PLMN and/or RAN, as described herein, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In another embodiment, the transceiver 925 includes a first transceiver that supports a radio interface with a remote unit 105 and further includes a second transceiver that supports a network interface with a core network entity and/or a radio network entity. In certain embodiments, the first transceiver (i.e., of the radio interface) and second transceiver (i.e., of the network interface) are logically separate transceivers that share one or more hardware components. For example, certain transceivers 925, transmitters 930, and receivers 935 may be implemented as physically separate components that access a shared hardware resource and/or software resource. Here, the network apparatus 900 may communicate with a core network entity and/or a radio network entity using a wireless backhaul link. In other embodiments, the first transceiver and second transceiver comprise physically separate transceiver hardware. For example, the network apparatus 900 may communicate with a core network entity and/or a radio network entity using a wireline link.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one more common control signals or as modular transmitters 930 and receivers 935 implemented in the same hardware chip or in a multi-chip module.

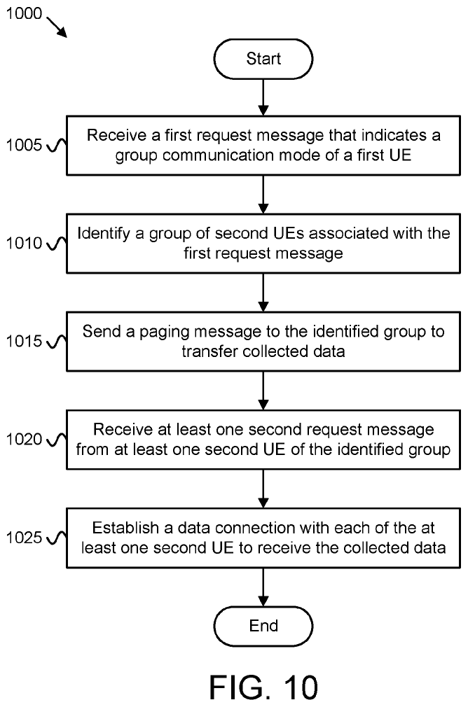

FIG. 10 depicts one embodiment of a method 1000 for retrieving collected data from a group of devices, according to embodiments of the disclosure. In various embodiments, the method 1000 is performed by Access and Mobility Management Function (“AMF”) entity, such as the AMF 143, the AMF 311, the AMF 411, the AMF 611, the AMF 715, and/or the network apparatus 900, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a first request message that indicates a group communication mode of a first UE. The method 1000 includes identifying 1010 a group of second UEs associated with the first request message. The method 1000 includes sending 1015 a paging message to the identified group to transfer collected data. The method 1000 includes receiving 1020 at least one second request message from at least one second UE of the identified group. The method 1000 includes establishing 1025 a data connection with each of the at least one second UE to receive the collected data. The method 1000 ends.

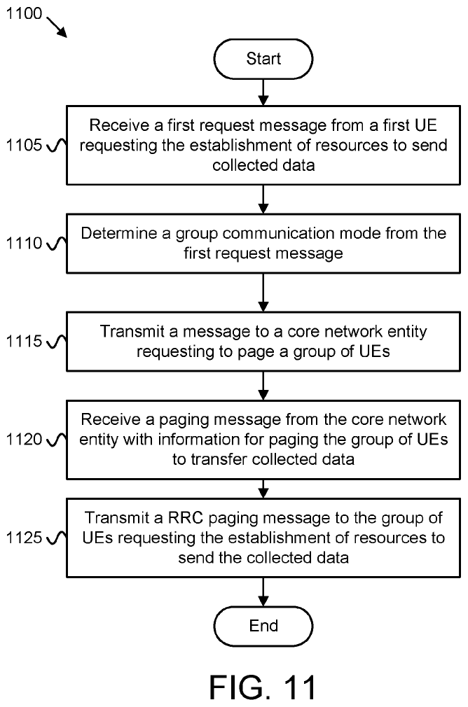

FIG. 11 depicts one embodiment of a method 1100 for retrieving collected data from a group of devices, according to embodiments of the disclosure. In various embodiments, the method 1100 is performed by a RAN entity, such as the base unit 121, the first gNB 209, the second gNB 211, the gNB 309, the gNB 409, the first gNB 607, the second gNB 609, the RAN node 710, and/or the network apparatus 900, as described above. In some embodiments, the method 1100 is performed by a processor, such as a microcontroller, a microprocessor, a CPU, a GPU, an auxiliary processing unit, a FPGA, or the like.

The method 1100 begins and receives 1105 a first request message from a first UE requesting the establishment of resources to send collected data. The method 1100 includes determining 1110 a group communication mode from the first request message. The method 1100 includes transmitting 1115 a message to a core network entity requesting to page a group of UEs. The method 1100 includes receiving 1120 a paging message from the core network entity with information for paging the group of UEs to transfer collected data. The method 1100 includes transmitting 1125 a RRC paging message to the group of UEs requesting the establishment of resources to send the collected data. The method 1100 ends.

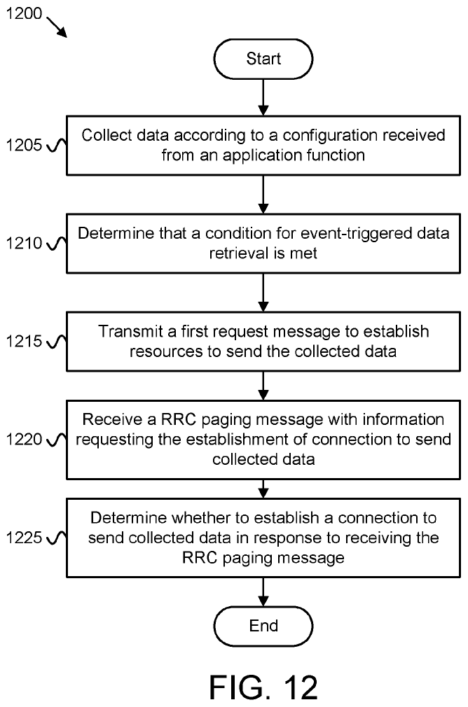

FIG. 12 depicts one embodiment of a method 1200 for retrieving collected data from a group of devices, according to embodiments of the disclosure. In various embodiments, the method 1200 is performed by a communication device, such as the remote unit 105, the UE-A 201, the UE-B 203, the UE-C 205, the first UE 301, the second UE 303, the third UE 305, the first UE 401, the second UE 403, the third UE 405, the first UE 601, the second UE 603, the third UE 605, the UE 705, and/or the user equipment apparatus 800, as described above. In some embodiments, the method 1200 is performed by a processor, such as a microcontroller, a microprocessor, a CPU, a GPU, an auxiliary processing unit, a FPGA, or the like.

The method 1200 begins and collects data 1205 according to a configuration received from an application function. The method 1200 includes determining 1210 that a condition for event-triggered data retrieval is met. The method 1200 includes transmitting 1215 a first request message to establish resources to send the collected data. The method 1200 includes receiving 1220 a RRC paging message with information requesting the establishment of connection to send collected data. The method 1200 includes determining 1225 whether to establish a connection to send collected data in response to receiving the RRC paging message. The method 1200 ends.

Disclosed herein is a first apparatus for to retrieve data collected from a group of devices, according to embodiments of the disclosure. The first apparatus may be implemented by an Access and Mobility Management Function (“AMF”) entity, such as the AMF 143, the AMF 311, the AMF 411, the AMF 611, the AMF 715, and/or the network apparatus 900, described above. The first apparatus includes a controller (e.g., the processor 605) and a transceiver (e.g., implementing a network interface) that receives a first request message indicating a group communication mode of a first UE. The controller identifies a group of second UEs associated with the first request message and the transceiver sends a paging message to the identified group to transfer collected data. The transceiver further receives at least one second request message from at least one second UE of the identified group and the controller establishes a data connection with each of the at least one second UE to receive the collected data.

In some embodiments, sending the paging message to the identified group comprises sending a NG paging message to at least one RAN node associated with a second UE. In such embodiments, the NG paging message comprises a paging cause value that indicates a MO data retrieval. In certain embodiments, the NG paging message further indicates a first traffic type included in the first request message. In one embodiment, the paging cause value jointly encodes MO data retrieval and the first traffic type.

In some embodiments, the first request message comprises a first group communication mode identity. In such embodiments, a UE identity parameter of the NG paging message is set to the first group communication mode identity. In some embodiments, the second request message comprises a first group communication mode identity included in the first request message.

In some embodiments, at least one second UE is in a non-connected state (e.g., in IDLE state or INACTIVE state) when the first request message is received. In some embodiments, establishing a data connection with a second UE comprises receiving (e.g., at the AMF) a PDU Session Establishment request message, said request message comprising at least one of: a first group communication mode identity included in the first request message and a first traffic type included in the first request message.

In some embodiments, the first request message comprises a service request message from the first UE. In some embodiments, the first request message comprises a paging request received from a RAN node serving the first UE.

Disclosed herein is a first method for to retrieve data collected from a group of devices, according to embodiments of the disclosure. The first method may be performed by an Access and Mobility Management Function (“AMF”) entity, such as the AMF 143, the AMF 311, the AMF 411, the AMF 611, the AMF 715, and/or the network apparatus 900, described above. The first method includes receiving a first request message that indicates a group communication mode of a first UE. The first method includes identifying a group of second UEs associated with the first request message and sending a paging message to the identified group to transfer collected data. The first method includes receiving at least one second request message from at least one second UE of the identified group and establishing a data connection with each of the at least one second UE to receive the collected data.

In some embodiments, sending the paging message to the identified group comprises sending a NG paging message to at least one RAN node associated with a second UE. In such embodiments, the NG paging message comprises a paging cause value that indicates a MO data retrieval.

In certain embodiments, the NG paging message further indicates a first traffic type included in the first request message. In one embodiment, the paging cause value jointly encodes MO data retrieval and the first traffic type.

In certain embodiments, the first request message comprises a first group communication mode identity. In such embodiments, a UE identity parameter of the NG paging message is set to the first group communication mode identity. In some embodiments, the second request message comprises a first group communication mode identity included in the first request message.

In some embodiments, at least one second UE is in a non-connected state (e.g., in IDLE state or INACTIVE state) when the first request message is received. In some embodiments, establishing a data connection with a second UE comprises receiving (e.g., at the AMF) a PDU Session Establishment request message, said request message comprising at least one of: a first group communication mode identity included in the first request message and a first traffic type included in the first request message.

In some embodiments, the first request message comprises a service request message received from the first UE. In some embodiments, the first request message comprises a paging request received from a RAN node serving the first UE.

Disclosed herein is a second apparatus for to retrieve data collected from a group of devices, according to embodiments of the disclosure. The second apparatus may be implemented by a device in a radio access network (“RAN”), such as the base unit 121, the first gNB 209, the second gNB 211, the gNB 309, the gNB 409, the first gNB 607, the second gNB 609, the RAN node 710, and/or the network apparatus 900, as described above, described above. The second apparatus includes a first transceiver (e.g., implementing a radio interface) that receives a first request message from a first UE requesting the establishment of resources to send collected data and a controller (i.e., the processor 605) that determines a group communication mode from the first request message. The second apparatus includes a second transceiver (e.g., implementing a network interface) that sends a message to a core network entity with information requesting to page a group of UEs and receives a first paging message from the core network entity with information for paging the group of UEs to transfer collected data. In response to the first paging message, the first transceiver transmits a RRC paging message to the group of UEs requesting the establishment of resources to send the collected data.

In some embodiments, transmitting the message to the core network entity comprises sending a paging request in response to determining the group communication mode. In certain embodiments, the paging request comprises a first group communication mode identity, where a UE identity parameter of the RRC paging message is set to the first group communication mode identity.

In some embodiments, receiving the first paging message comprises receiving an NG paging message from an AMF associated with the first UE. In certain embodiments, the NG paging message comprises a paging cause value that indicates a MO data retrieval. In certain embodiments, the NG paging message further indicates a first traffic type included in the first request message. In one embodiment, the paging cause value jointly encodes MO data retrieval and the first traffic type.

In some embodiments, the second transceiver further sends a RAN paging message to at least one second RAN entity in response to receiving the first paging message from the core network entity. In such embodiments, the at least one second RAN entity is part of a RAN notification area associated with a non-connected UE (e.g., in IDLE state or INACTIVE state) of the group of UEs.

In certain embodiments, the RAN paging message comprises a paging cause value that indicates a MO data retrieval. In certain embodiments, the RAN paging message further indicates a first traffic type included in the first request message. In one embodiment, the paging cause value jointly encodes MO data retrieval and the first traffic type.

In some embodiments, the controller further performs an RRC connection establishment procedure with at least one second UE of the group of UEs. In such embodiments, the first transceiver further receives collected data from the at least one second UE. In one embodiment, the first transceiver and second transceiver are logically separate transceivers that share communication resources. In other embodiments, the first transceiver and second transceiver comprise physically separate transceiver hardware.

Disclosed herein is a second method for to retrieve data collected from a group of devices, according to embodiments of the disclosure. The second method may be performed by a d RAN entity, such as the base unit 121, the first gNB 209, the second gNB 211, the gNB 309, the gNB 409, the first gNB 607, the second gNB 609, the RAN node 710, and/or the network apparatus 900, as described above, described above. The second method includes receiving a first request message from a first UE requesting the establishment of resources to send collected data. The second method includes determining a group communication mode from the first request message and transmitting a message to a core network entity requesting to page a group of UEs. The second method includes receiving a paging message from the core network entity with information for paging the group of UEs to transfer collected data and transmitting a RRC paging message to the group of UEs requesting the establishment of resources to send the collected data.

In some embodiments, transmitting the message to the core network entity comprises sending a paging request in response to determining the group communication mode. In certain embodiments, the paging request comprises a first group communication mode identity, where a UE identity parameter of the RRC paging message is set to the first group communication mode identity.

In some embodiments, receiving the paging message comprises receiving an NG paging message from an AMF associated with the first UE. In certain embodiments, the NG paging message comprises a paging cause value that indicates a MO data retrieval. In certain embodiments, the NG paging message further indicates a first traffic type included in the first request message. In one embodiment, the paging cause value jointly encodes MO data retrieval and the first traffic type.

In some embodiments, the second method further includes sending a RAN paging message to at least one second RAN entity in response to receiving the paging message from the core network entity. In such embodiments, the at least one second RAN entity is part of a RAN notification area associated with a non-connected UE (e.g., in IDLE state or INACTIVE state) of the group of UEs.

In some embodiments, the RAN paging message comprises a paging cause value that indicates a MO data retrieval. In certain embodiments, the RAN paging message further indicates a first traffic type included in the first request message. In one embodiment, the paging cause value jointly encodes MO data retrieval and the first traffic type.

In some embodiments, the second method further includes performing an RRC connection establishment procedure with at least one second UE of the group of UEs and receiving collected data from the at least one second UE.

Disclosed herein is a third apparatus for to retrieve data collected from a group of devices, according to embodiments of the disclosure. The third apparatus may be implemented by a communication device, such as the remote unit 105, the UE-A 201, the UE-B 203, the UE-C 205, the first UE 301, the second UE 303, the third UE 305, the first UE 401, the second UE 403, the third UE 405, the first UE 601, the second UE 603, the third UE 605, the UE 705, and/or the user equipment apparatus 800, described above. The third apparatus includes a transceiver (e.g., implementing a radio interface) and a processor that collects data in accordance with configuration received from an application function and determines that a condition for event-triggered data retrieval is met. The transceiver transmits a message to a network entity with information requesting the establishment of resources to send collected data and receives a message from the network entity with information requesting the establishment of connection to send collected data. In response to receiving the RRC paging message, the processor determines whether to request establishment of connection to send collected data in accordance with the received RRC paging message.

Disclosed herein is a third method for to retrieve data collected from a group of devices, according to embodiments of the disclosure. The third method may be performed by a communication device, such as the remote unit 105, the UE-A 201, the UE-B 203, the UE-C 205, the first UE 301, the second UE 303, the third UE 305, the first UE 401, the second UE 403, the third UE 405, the first UE 601, the second UE 603, the third UE 605, the UE 705, and/or the user equipment apparatus 800, described above. The third method includes collecting data according to a configuration received from an application function. The third method includes determining that a condition for event-triggered data retrieval is met and transmitting a first request message to establish resources to send the collected data. The third method includes receiving a RRC paging message with information requesting the establishment of connection to send collected data and determining whether to establish a connection to send collected data in response to receiving the RRC paging message.

Disclosed herein is a system to retrieve data collected from a group of communication devices, according to embodiments of the disclosure. The system comprises: a first communication network entity, a second communication network entity, and a group of associated devices, including a first communication device (e.g., a first UE) and at least one second communication device. The first communication device (e.g., a first UE) transmits a first message to a first communication network entity, said first message requesting the establishment of resources to send collected data. The first communication network entity determines the other devices in the group of associated devices, said determination based on information received from the first communication device.

The first communication network entity transmits a second message to a second communication network entity, said second message comprising information for paging a first group of communication devices. The second communication network entity transmits a third message to the first group of communication devices, said third message comprising information requesting the establishment of resources to send collected data in accordance with the second message. Here, at least one second communication device determines to request establishment of connection to send collected data and sends a request to the first communication network entity to establish resources to send collected data.

In some embodiments, the information in the first message requesting the establishment of resources to send collected data includes a group communication mode identity, a data traffic type and/or a paging cause. In some embodiments, the third message includes a group communication mode identity, a data traffic type and/or a paging cause.

In some embodiments, the first communication network entity is a core network Access and Mobility Management Function (“AMF”) entity, and the second communication network entity is a radio network 5G base station (“gNB”). In certain embodiments, the second message comprises an NG paging message sent to at least one gNB. In such embodiments, the third message comprises at least RRC paging message sent to at least one device belonging to the first group of communication devices.

In other embodiments, the first communication network entity is a gNB and the second communication network entity is a core network AMF entity. In certain embodiments, the second message comprises an NG paging request message sent to the AMF entity, said paging request message comprising information requesting to page a group of devices. In such embodiments, the second communication network entity transmitting the third message comprises the AMF sending an NG paging message to the gNB, said NG paging message comprising information for paging the group of devices.

Disclosed herein is a fourth method to retrieve data collected from a group of communication devices in a communication network, according to embodiments of the disclosure. The fourth method may be performed by a system comprising: a first communication network entity, a second communication network entity, and a group of associated devices, including a first communication device (e.g., a first UE) and at least one second communication device.

The fourth method includes transmitting a message from a first communication device to a first communication network entity requesting the establishment of resources to send collected data and determining by the first communication network entity the other devices in the group of associated devices in accordance with the information received from the first communication device. The fourth method includes transmitting a message from the first communication network entity to a second communication network entity with information for paging a first group of communication devices.

The fourth method includes transmitting a message from the second communication network entity to the first group of communication devices with information requesting the establishment of connection to send collected data in accordance with the received message from the first communication network entity and receiving the message from the second communication network entity by the first group of communication devices. The fourth method includes determining by the first group of communication devices whether to request establishment of connection to send collected data and transmitting a message from the first group of communication devices to the first communication network entity—followed by a request to the second communication network entity requesting the establishment of resources to send collected data.

In some embodiments, the information requesting the establishment of resources to send collected data includes a group communication mode identity, a data traffic type and/or a paging cause. In some embodiments, the information for paging a group of devices includes a group communication mode identity, a data traffic type and/or a paging cause.

In some embodiments, the first communication network entity is a core network AMF entity, and the second communication network entity is a gNB. In other embodiments, the first communication network entity is a gNB and the second communication network entity is a core network AMF entity. In such embodiments, the fourth method includes determining by the second first network entity a group communication mode in accordance with the information received from the first communication device and transmitting a message from the first communication network entity to the second communication network entity with information requesting to page a group of devices.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. An apparatus comprising:
a processor; and
a memory coupled to the processor, the memory comprising instructions executable by the processor to cause the apparatus to:
receive a first request message indicating a group communication mode of a first User Equipment (“UE”);
identify a group of second UEs associated with the first request message;
transmit a paging message to the identified group to transfer collected data;
receive at least one second request message from at least one second UE of the identified group; and
establish a data connection with each of the at least one second UE to receive the collected data.

17. The apparatus of claim 16, wherein to transmit the paging message to the identified group, the instructions are further executable by the processor to cause the apparatus to transmit a NG paging message to at least one radio access network (“RAN”) node associated with a second UE, wherein the NG paging message comprises a paging cause value that indicates a Mobile-Originated (“MO”) data retrieval.

18. The apparatus of claim 17, wherein the NG paging message further indicates a first traffic type included in the first request message.

19. The apparatus of claim 17, wherein the first request message comprises a first group communication mode identity, wherein a UE identity parameter of the NG paging message is set to the first group communication mode identity.

20. The apparatus of claim 16, wherein the second request message comprises a first group communication mode identity included in the first request message.

21. The apparatus of claim 16, wherein to establish a data connection with a second UE, the instructions are further executable by the processor to cause the apparatus to receive a Protocol Data Unit (“PDU”) Session Establishment request message comprising at least one of:
a first group communication mode identity included in the first request message,
a first traffic type included in the first request message,
or a combination thereof.

22. The apparatus of claim 16, wherein the first request message comprises a paging request received from a RAN node serving the first UE.

23. A method of a communication node in a communication network, the method comprising:
receiving a first request message indicating a group communication mode of a first User equipment (“UE”);
identifying a group of second UEs associated with the first request message;
transmitting a paging message to the identified group to transfer collected data;
receiving at least one second request message from at least one second UE of the identified group; and
establishing a data connection with each of the at least one second UE to receive the collected data.

24. The method of claim 23, wherein transmitting the paging message to the identified group comprises transmitting a NG paging message to at least one radio access network (“RAN”) node associated with a second UE, wherein the NG paging message comprises a paging cause value that indicates a Mobile-Originated (“MO”) data retrieval.

25. The method of claim 24, wherein the NG paging message further indicates a first traffic type included in the first request message.

26. The method of claim 24, wherein the first request message comprises a first group communication mode identity, wherein a UE identity parameter of the NG paging message is set to the first group communication mode identity.

27. The method of claim 23, wherein the first request message comprises a paging request received from a RAN node serving the first UE, and wherein the second request message comprises a first group communication mode identity included in the first request message.

28. The method of claim 23, wherein establishing a data connection with a second UE comprises receiving a Protocol Data Unit (“PDU”) Session Establishment request message comprising at least one of:
a first group communication mode identity included in the first request message,
a first traffic type included in the first request message,
or a combination thereof.

29. An apparatus comprising:
a processor; and
a memory coupled to the processor, the memory comprising instructions executable by the processor to cause the apparatus to:
receive a first request message from a first User Equipment (“UE”) requesting the establishment of resources to send collected data;
determine a group communication mode from the first request message;
transmit a message to a core network entity requesting to page a group of UEs;
receive a paging message from the core network entity with information for paging the group of UEs to transfer collected data; and
transmit a Radio Resource Control (“RRC”) paging message to the group of UEs requesting the establishment of resources to send the collected data.

30. The apparatus of claim 29, wherein to transmit the message to the core network entity, the instructions are further executable by the processor to cause the apparatus to transmit a paging request in response to determining the group communication mode.

31. The apparatus of claim 30, wherein the paging request comprises a first group communication mode identity, wherein a UE identity parameter of the RRC paging message is set to the first group communication mode identity.

32. The apparatus of claim 29, wherein to receive the paging message from the core network entity, the instructions are further executable by the processor to cause the apparatus to receive a NG paging message from an Access and Mobility management Function (“AMF”) associated with the first UE, wherein the NG paging message comprises a paging cause value that indicates a Mobile-Originated (“MO”) data retrieval.

33. The apparatus of claim 32, wherein the NG paging message further indicates a first traffic type included in the first request message.

34. The apparatus of claim 29, wherein the instructions are further executable by the processor to cause the apparatus to transmit a RAN paging message to at least one second RAN entity in response to receiving the paging message from the core network entity, wherein the at least one second RAN entity is part of a RAN notification area associated with a non-connected UE of the group of UEs, wherein the RAN paging message comprises a paging cause value that indicates a Mobile-Originated (“MO”) data retrieval, wherein the RAN paging message further indicates a first traffic type included in the first request message.

35. The apparatus of claim 29, wherein the instructions are further executable by the processor to cause the apparatus to:
perform an RRC connection establishment procedure with at least one second UE of the group of UEs, and
receive collected data from the at least one second UE.
